(19) United States
(12) Patent Application Publication
(10) Pub. No.: US 2009/0011166 A1
(43) Pub. Date: Jan. 8, 2009

(54) ADHESIVE TAPE COMPOSITION FOR ELECTRONIC COMPONENTS

(75) Inventors: Sang-Pil KIM, Gumi-si (KR); Hae-Sang Jun, Gumi-si (KR); Woo-Seok Kim, Goyang-si (KR); Se-Young Cha, Andong-si (KR)

Correspondence Address: HARNESS, DICKEY, & PIERCE, P.L.C, 7700 Bonhomme, Suite 400, ST. LOUIS, MO, 63105, US

(73) Assignee: TORAY SAEHAN, INC., Gyeongsangbuk-do (KR)

(21) Appl. No.: 12/190,241

(22) Filed: Aug. 12, 2008

Related U.S. Application Data
(62) Division of application No. 11/107,894, filed on Apr. 18, 2005.

(30) Foreign Application Priority Data
Oct. 22, 2004 (KR) 10-2004-0084712

(51) Int. Cl. C09J 109/02; B32B 33/00; B32B 27/06; C08L 63/10; B32B 27/32; C09J 7/02

(52) U.S. Cl. 428/41.8; 428/473.5; 428/523; 428/337; 525/109

(57) ABSTRACT

The present invention pertains to an adhesive tape composition for electronic components used for bonding electronic components used in semiconductor devices, e.g., leads, PRH, semiconductor chips, die pads, etc. In particular, the present invention concerns an adhesive tape composition excellent in electric reliability, adhesive strength and taping workability.

The adhesive tape composition according to the present invention is characterized in that it contains acrylonitrile butadiene rubber (NBR) containing the carboxyl functional group at the end thereof, epoxy resin, phenol resin and one or more sorts of hardener selected from amine and acid anhydride hardeners.

### BACKGROUND OF THE INVENTION

1. Technical Field

The present invention relates to an adhesive tape composition, and, more particularly, to an adhesive tape composition for electronic components that can be used for bonding electronic components such as FPC (Flexible Printed Circuit boards), TAB (Tape Automated Bonding), leads of lead frames, PRH (plate of radiant heat), semiconductor chips, die pads, and the like, used in semiconductor devices.

2. Description of the Prior Art

Generally, typical adhesive tapes used for semiconductor devices include adhesive tapes for fixing lead frames, those for attaching PRH, TAB tapes, LOC (Lead On Chip) tapes, and the like. The adhesive tape for fixing lead frames is used for fixing the lead of a lead frame to improve productivity, yields, and lead frame itself in the overall semiconductor assembly process. A lead frame manufacturer applies the adhesive tape onto a lead frame, which is in turn delivered to a semiconductor assembling company, to equip semiconductor chips on the frame which is subject to wire bonding, etc. and then to seal the frame with an epoxy molding compound. Therefore the adhesive tape is contained in a semiconductor package. The tapes such as the adhesive tape for attaching PRH are also contained in a semiconductor package as well as the adhesive tapes for fixing lead frames are.

Therefore, the adhesive tapes for electronic components must have general reliability and workability in taping for semiconductors, and sufficient physical properties that can resist severe conditions such as high temperature, humidity, voltage, etc. applied from the outside during the assembling process of a semiconductor device and while being used as a finished product after the assembling process, as well as adhesive strength.

Use of typical adhesive tapes for electronic components used as such is made by applying only the synthetic rubbery resin of polyacrylonitrile resin, polyacrylate resin, resol phenol resin, or acrylonitrile-butadiene copolymer, etc. onto a heat-resistant film such as a polyimide film, or by applying an adhesive made by modifying the resins to another resin or mixing the resins, and then applying an adhesive tape converted at B stage through the steps of coating and drying the applied adhesive. The tape, however, does not have sufficient thermal resistance, so that the tape cannot endure the heating condition at high temperature (up to 260° C.) during a process of assembling semiconductor devices produced recently.

Recently, thermosetting imide resin has been applied in order to solve the aforementioned problems. Since heat and pressure applied for attaching and fixing the resin to an adhesion substrate such as a lead frame and the like is very high, however, the adhesion substrate, e.g. the lead may be transformed in taping (bonding) and metal materials such as a taping tool, etc. may be damaged

With the micro- and highly-integrated package architecture resulting from a thin body and fine pitch structure of a semiconductor device, severe requirements for organic materials such as adhesive tapes and the like used for the devices tend to be applied to their electric, chemical and physical properties. Accordingly, there has been a need for developing adhesive tape compositions for electronic components excellent in adhesive strength, workability and the like together with sufficient electric reliability and durability.

To solve the aforementioned problems, the applicant TORAY SAEHAN disclosed a “Heat-resistant adhesive tape for electronic components”, in the Korea Pat. Publication No. 2004-0009616. With the composition disclosed in the above patent specification, many problems in adhesive strength, electric reliability and the like were much improved as compared to conventional adhesive tapes used before and it has been widely used in the relevant field currently.

As electronic and semiconductor components continue to develop with a micro-, thin- and highly-integrated structure, there has been a need for continuous development of adhesive tapes for electronic components. The present invention was completed during the research.

### BRIEF SUMMARY OF THE INVENTION

The present invention was conceived to solve the aforementioned problems. It is an object of the present invention to provide an adhesive tape composition excellent in adhesive strength and taping workability and with sufficient heat resistance and excellent electric reliability when attaching electronic components.

### BRIEF DESCRIPTION OF THE DRAWINGS

The features and advantages of the present invention will become apparent when reading the following detailed description of preferred embodiments thereof illustrated with reference to the accompanying drawings, wherein:

FIG. 1 is a cross sectional view of a tape made of an adhesive tape composition for electronic components according to one embodiment of the present invention;

FIG. 2 is a cross sectional view of another tape made of an adhesive tape composition for electronic components according to one embodiment of the present invention;

FIG. 3 shows schematically a specimen for testing electric reliability of an adhesive tape for electronic components, made of the adhesive tape composition for electronic components according to one embodiment of the present invention; and

FIG. 4 is a cross sectional view of a specimen for testing electric reliability of an adhesive tape for electronic components, made of the adhesive tape composition for electronic components according to one embodiment of the present invention

### DETAILED DESCRIPTION OF THE PREFERRED EMBODIMENT

The adhesive tape composition according to the present invention to achieve the aforementioned object is characterized in that it contains 100 weight portions of acrylonitrile butadiene rubber (NBR) containing 1 to 20 weight % of carboxyl functional group, 5 to 300 weight portions of epoxy resin, 50 to 200 weight portions of phenol resin, 2 to 50 weight portions of one or more sorts of hardener selected from amine and anhydride hardeners.

Preferably, the NBR contains 10 to 60 weight % of acrylonitrile and 1 to 20 weight % of carboxyl functional group, and the weight average molecular weight thereof is preferably 3,000 to 200,000.

More preferably, the phenol resin is one or more sorts of phenol resin selected from novolac and resol resins, and the softening point thereof measured by means of the ring and ball method is 50 to 120° C.

Hereinafter, the present invention will be described in detail with reference to the embodiments and drawings. It will be apparent to those skilled in the art that these embodiments will be intended to describe the present invention more specifically, but the scope of the present invention will not be limited to the embodiments according to the subject of the present invention.

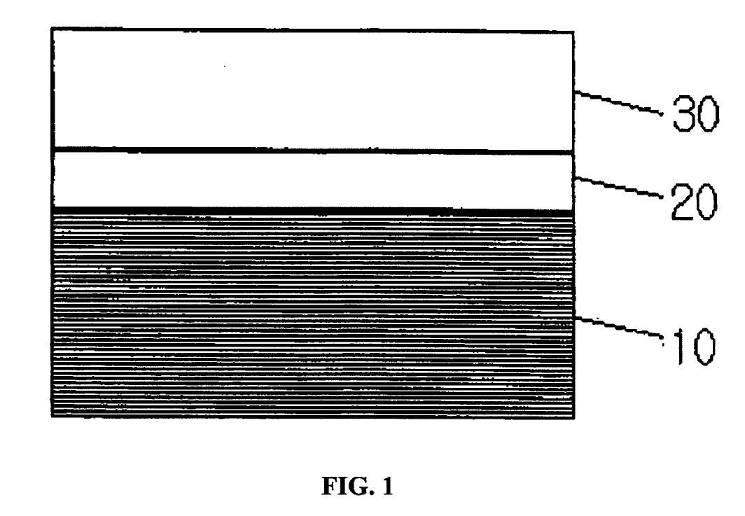

FIG. 1 is a cross sectional view of a tape made of an adhesive tape composition for electronic components according to one embodiment of the present invention. In the figure, on one surface of a heat-resistant film (10) is formed an adhesive layer (20) which is made of NBR containing the carboxyl functional group, epoxy resin, phenol resin, hardener, etc. On top of the layer (20), a release film (30) is laminated, as shown in FIG. 1.

The heat-resistant film (10) may be a heat-resistant film such as a polyimide, polyphenylenesulfide, or polyethyleneterephthalate film, but most preferably a polyimide film. If the heat-resistant film is too thick (70 μm or more) or too thin (10 μm or less), it is not easy to carry out tape punching in taping. Therefore, it is preferable that the thickness ranges 10 to 70 μm, more preferably 40 to 60 μm.

The adhesive layer (20) has a ratio of 3 to 300 weight portions of polyfunctional epoxy resin and 3 to 300 weight portions of polyfunctional phenol resin for 100 weight of NBR containing the carboxyl functional group, wherein hardener, a rubber cross linking agent and other additives are added thereto.

The aforementioned NBR containing the carboxyl functional group has 2,000 to 200,000 of a weight average molecular weight, preferably 3,000 to 200,000, 10 to 60 weight % of the acrylonitrile content, preferably 20 to 50 weight %, and 1 to 20 weight % of the carboxyl functional group content. In this case, if the weight average molecular weight is less than 2,000, it exhibits poor thermal stability. If it is more than 200,000, it exhibits poor solubility for a solvent, poor workability and lowered adhesive strength because viscosity increases in producing liquid. If the content of acrylonitrile is less than 10 weight %, solubility of solvent is lowered. The content of acrylonitrile more than 60 weight % causes poor electric insulation. If the content of the carboxyl functional group is 1 to 20 weight %, easy bonding between NBR and other resin, and adhesion substrates is achieved, resulting in increased adhesive strength.

5 to 300 weight portions of the epoxy resin used in the present invention are added for 100 weight of NBR. The used epoxy resin may be bisphenol-A type epoxy, bisphenol-F type epoxy or novolac epoxy, whose equivalent weight (g/eq) is 200 to 1000.

The phenol resin is one or more sorts of phenol resin selected from novolac and resol groups. For 100 weight of NBR, 5 to 300 weight portions of the phenol resin, preferably 50 to 200 weight portions are added. If the content of the phenol resin is more than 300 weight portions, the adhesive layer gets brittle, so that it cannot be used as an adhesive. The molecular weight of the used phenol resin is preferably 200 to 900. The softening point of the used resin measured by means of the ring and ball method is preferably 50 to 120° C. If a resin whose softening point is 50° C. or lower is used, the adhesive layer flows in taping of the adhesive tape for electronic components, reaching a taping tool or unwanted locations of a lead frame, which in turn causes failures in the taping tool or poor lead frames. On the contrary, if a resin whose softening point is 120° C. or higher is used, higher temperature must be applied for adhesion of the tape, which may cause thermal transformation of electronic components. Accordingly, a resin that has a proper softening point of 50 to 120° C. must be used.

For the hardener, an amine hardener and an acid anhydride can be used independently or together, and 2 to 50 weight portions of the hardener with respect to 100 weights of NBR is preferably used. For the rubber cross linking agent, organic or inorganic peroxide can be used. It is preferable to add 1 to 5 weight portions with respect to 100 weights of NBR to the agent.

The adhesive layer (20) made of the adhesive tape composition as described above has a viscosity of 100˜2,000 CPS, preferably 400˜1,500 CPS. The layer (20) is applied on the heat-resistant film (10) so that its thickness after drying can be 10 to 30 μm. After curing the layer at 50 to 200° C. for 2 to 10 minutes, a release film (30) is attached thereto to obtain an adhesive tape for electronic components.

The release film (30) has a thickness of 20 to 100 μm, preferably 30 to 60 μm. The release film may be a polyethylene, polyethylene terephthalate, or polypropylene film, to which release capability may be given with silicon resin, if required.

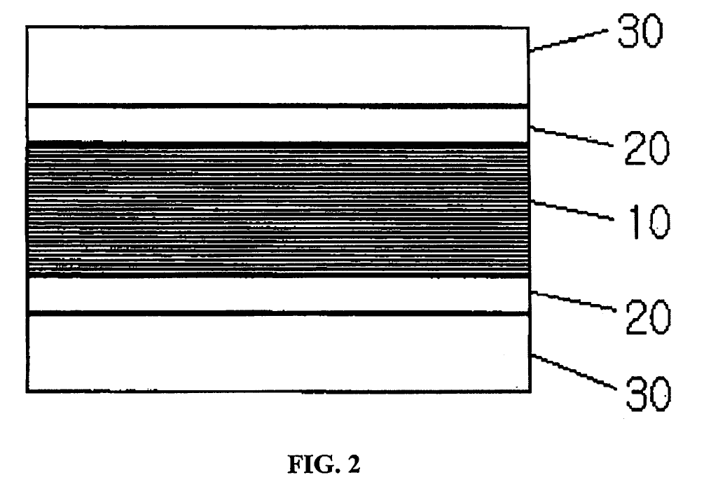

FIG. 2 is a cross sectional view of another tape made of an adhesive tape composition for electronic components according to one embodiment of the present invention, wherein adhesive layers (20) are formed on both sides of a heat-resistant film (10) and a release film (30) is laminated on the surface of each adhesive layer (20).

### Embodiment 1

To 200 weight portions of NBR (containing 27.1 weight % of the acrylonitrile content and 4.3 weight % of the carboxyl functional group content) were added 100 weight portions of novolac epoxy resin represented in the following chemical structure 1, 100 weight portions of phenol resin represented in the following chemical structure 2, 3 weight portions of hexamethoxy methylmelamine as hardener and 3 weight portions of phthalic anhydride, and then 10 weight portions of zinc oxide as a rubber cross linking agent. The viscosity of the resulting solution was then adjusted to 400 to 1,500 CPS, using acetone solvent. Subsequently the adhesive liquid was sufficiently mixed, and then applied onto the surface of a polyimide film whose thickness was 50 μm so that the thickness of the adhesive layer can be 20 μm after being dried. After drying the adhesive layer (at 160° C., for 3 minutes), a polyethylene terephthalate film whose thickness was 38 μm was laminated to produce an adhesive tape.

[Chemical Structure 1]

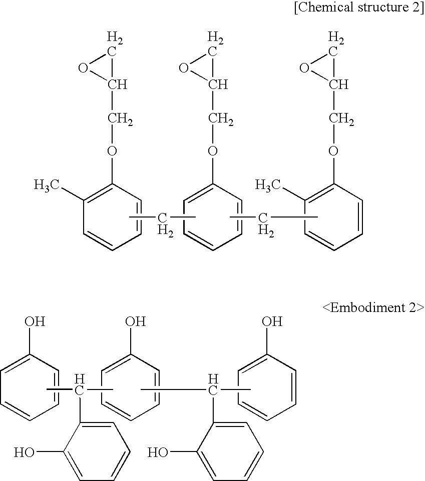

An adhesive tape was produced with the same method as in the embodiment 1, using the adhesive produced by replacing only the phenol resin with the phenol resin represented in the following chemical structure 3, in the composition of the embodiment 1.

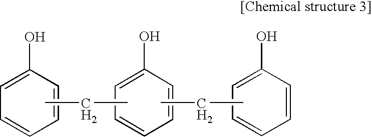

### Embodiment 3

An adhesive tape was produced with the same method as in the embodiment 1, using the adhesive produced by replacing only the phenol resin with the phenol resin represented in the following chemical structure 4, in the composition of the embodiment 1.

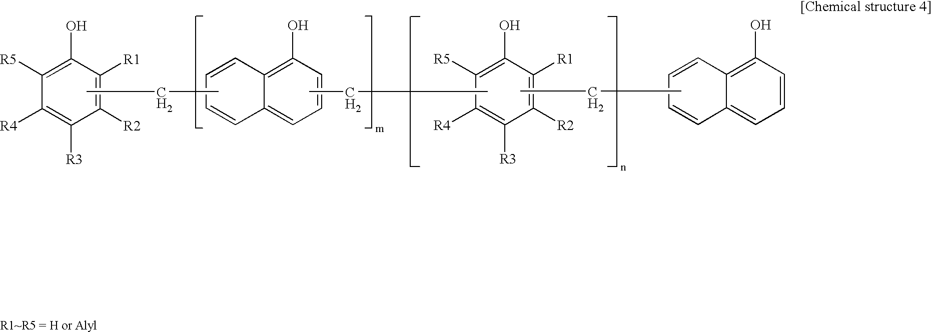

### Embodiment 4

An adhesive tape was produced with the same method as in the embodiment 1, using the adhesive produced by replacing only the phenol resin with the phenol resin represented in the following chemical structure 5, in the composition of the embodiment 1.

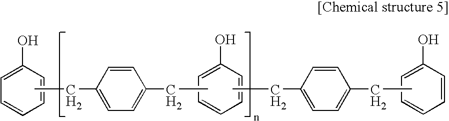

### Embodiment 5

An adhesive tape was produced with the same method as in the embodiment 1, using the adhesive produced by replacing only the phenol resin with the phenol resin represented in the following chemical structure 6, in the composition of the embodiment 1.

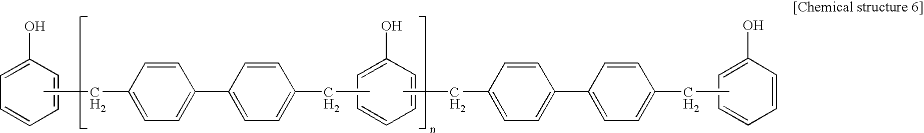

### Embodiment 6

An adhesive tape was produced with the same method as in the embodiment 1, using the adhesive produced by replacing only the phenol resin with the phenol resin represented in the following chemical structure 7, in the composition of the embodiment 1.

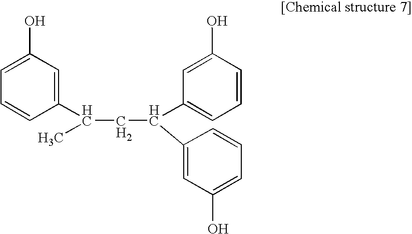

### Embodiment 7

An adhesive tape was produced with the same method as in the embodiment 1, using the adhesive produced by replacing only the phenol resin with the resin represented in the following chemical structure 8, in the composition of the embodiment 1.

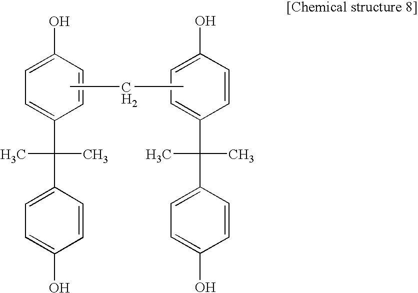

### Embodiment 8

An adhesive tape was produced with the same method as in the embodiment 1, using the adhesive produced by replacing only the phenol resin with the resin represented in the following chemical structure 9, in the composition of the embodiment 1.

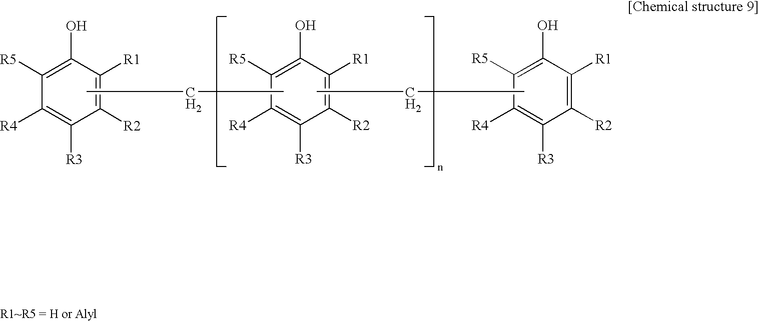

### Embodiment 9

An adhesive tape was produced with the same method as in the embodiment 1, using the adhesive produced by replacing only the phenol resin with the resin represented in the following chemical structure 10, in the composition of the embodiment 1.

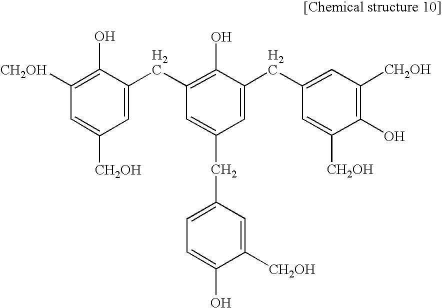

### Embodiment 10

An adhesive tape was produced with the same method as in the embodiment 1, using the adhesive produced by replacing only the epoxy resin with the resin represented in the following chemical structure 11, in the composition of the embodiment 1.

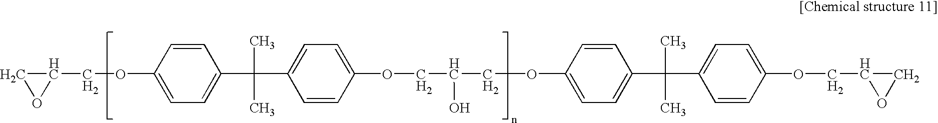

### Embodiment 11

An adhesive tape was produced with the same method as in the embodiment 1, using the adhesive produced by replacing only the epoxy resin with the resin represented in the following chemical structure 12, in the composition of the embodiment 1.

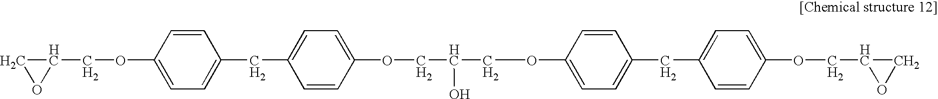

### Comparative Example 1

According to the method in the embodiment 1 according to the Korea Pat. Publication No. 1998-0068284 “Adhesive Composition for Heat-resistant Adhesive Tapes”, an adhesive tape was produced.

### Comparative Example 2

According to the method in the embodiment 1 according to the Korea Pat. Publication No. 2004-0009616 “Heat-resistant Adhesive Tapes for Electronic Components”, an adhesive tape was produced.

Method of Testing Properties

[Testing Adhesive Strength]

While placing a copper foil on a press constant at a temperature of 130° C., the adhesive tapes produced according to the embodiments and the comparative examples were thermocompressed for one second at a pressure of 10 kg/m² and were then measured about the 180° PEEL strength by means of a INSTRON.

[Testing Decomposition Temperature]

The adhesive were measured about decomposition temperature under nitrogen atmosphere by means of the DUPONT V4.1C 2200 model TGA.

[Testing Electric Reliability]

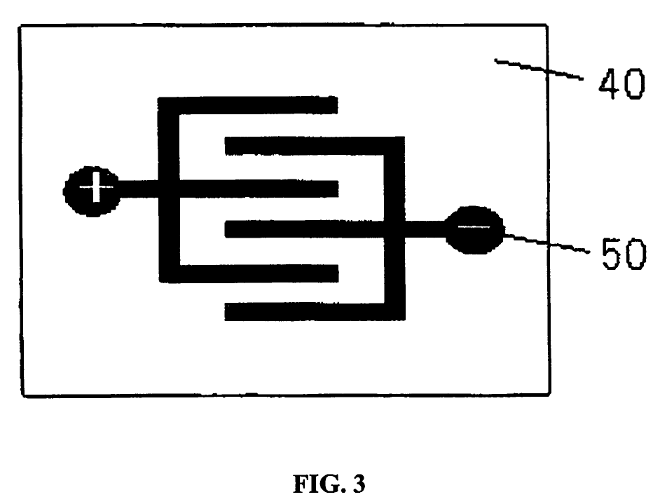

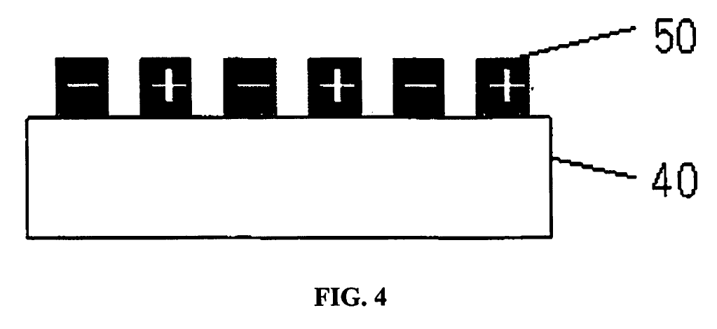

FIG. 3 is a schematic drawing of a specimen for testing electric reliability of an adhesive tape for electronic components made of the adhesive tape composition for electronic components according to one embodiment of the present invention. The specimen is made by etching a copper foil of a flexible circuit board (where the copper foil is laminated on a polyimide film). FIG. 4 is a cross sectional view of a specimen for testing electric reliability of an adhesive tape for electronic components, made of the adhesive tape composition for electronic components according to one embodiment of the present invention.

The adhesive tapes produced according to the embodiments and the comparative examples were thermo-compressed for two minutes at a pressure of 30 kg/m² on a specimen in which the inter-lead distance was 150% as shown in FIGS. 3 and 4. Subsequently the tapes were thermally treated for one hour at 170° C. The specimen was then tested about electric reliability in order to measure variations in resistance over time for 100 hours at 135° C., 85% of relative humidity and 5 volts.

The results of testing as described above are shown in Table 1, wherein the voltage drop time indicates the time when the resistance value of the specimen falls by 10² (order) or more due to the influence of the adhesive composition in testing electric reliability. “N” indicates the case where voltage drop does not occur for 100 hours.

TABLE 1

| | Adhesive | Decomposition | Voltage drop |
|---|---|---|---|
| Tested property | strength (g/cm) | temperature (°C) | time (hr) |
| Embodiment 1 | 3423 | 397 | N |
| Embodiment 2 | 3210 | 361 | N |
| Embodiment 3 | 3130 | 384 | N |
| Embodiment 4 | 3679 | 383 | N |
| Embodiment 5 | 3571 | 395 | N |
| Embodiment 6 | 2410 | 379 | 81 |
| Embodiment 7 | 2362 | 387 | 69 |
| Embodiment 8 | 3472 | 381 | N |
| Embodiment 9 | 3104 | 359 | 78 |
| Embodiment 10 | 2940 | 337 | 91 |
| Embodiment 11 | 3020 | 343 | 87 |
| Comparative | 715 | 328 | 28 |
| example 1 | | | |
| Comparative | 2600 | 324 | 42 |
| example 2 | | | |

As shown in the above Table 1, the adhesive tapes for electronic components made of the adhesive tape composition for electronic components according to the present invention is excellent in adhesive strength and decomposition temperature, which is a basic property of an adhesive tape for electronic components, and have sufficient thermal resistance as compared with a conventional tape for electronic components whose adhesive strength is 600 g/cm and decomposition temperature is 280° C. The tapes made of the adhesive tape composition according to the present invention are excellent in electric reliability that is an important object of the present invention, as compared with conventional tapes for electronic components.

In the description of the present invention, only some examples were described among many cases of production and analyzing test carried out by the inventors, but it should be noted that the technical scope of the present invention will not be limited to them and those skilled in the art can modify and apply them to different applications.

1-3. (canceled)

4. An adhesive tape comprising:
a heat-resistant film, and
an adhesive layer disposed on the heat-resistant film,
wherein the adhesive layer comprises 100 weight portions of acrylonitrile butadiene rubber (NBR) including 1 to 20 weight % of carboxyl functional group and 10 to 60 weight % of acrylonitrile and having an average molecular weight of 3,000 to 200,000,
5 to 300 weight portions of epoxy resin,
50 to 200 weight portions of phenol resin, and
2 to 50 weight portions of one or more hardeners selected from amine and acid anhydride hardeners.

5. The adhesive tape of claim 4 further comprising a release film, wherein the adhesive layer is disposed between the heat-resistant film and the release film.

6. The adhesive tape of claim 5, wherein the release film is selected from polyethylene, polyethylene terephthalate, and polypropylene films.

7. The adhesive tape of claim 4, wherein the heat-resistant film includes one or more selected from the group of polyimide, polyphenylenesulfide, and polyethylene terephthalate.

8. The adhesive tape of claim 4, wherein the thickness of the heat-resistant film is 10 to 70 μm.

9. The adhesive tape of claim 4, wherein the NBR includes about 27.1 weight % of acrylonitrile and about 4.3 weight % of the carboxyl functional group.

10. The adhesive tape of claim 4, wherein the phenol resin comprises one or more phenol resin selected from novolac and resol groups, and wherein the softening point of the resin measured by means of the ring and ball method is 50 to 120° C.

11. The adhesive tape of claim 4, wherein the epoxy resin has the formula:

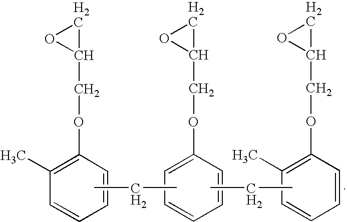

12. The adhesive tape of claim 4, wherein the phenol resin has the formula:

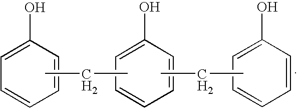

13. The adhesive tape of claim 4, wherein the adhesive layer has a viscosity of 100 to 2,000 CPS.
